(19) United States
(12) Patent Application Publication
(10) Pub. No.: US 2005/0278664 A1
(43) Pub. Date: Dec. 15, 2005

(54) Predicting power consumption for a chip

(75) Inventors: Rajat Chaudhry, Austin, TX (US); Sang Hoo Dhong, Austin, TX (US); Stephen Douglas Posluszny, Round Rock, TX (US); Daniel Lawrence Stasiak, Rochester, MN (US)

Correspondence Address: IBM CORP. (WIP);c/o WALDER INTELLECTUAL PROPERTY LAW, P.C., P.O. BOX 832745, RICHARDSON, TX, 75083, US

(73) Assignee: International Business Machines Corporation, Armonk, NY (US)

(21) Appl. No.: 10/855,725

(22) Filed: May 27, 2004

(51) Int. Cl. G06F 9/45; G06F 17/50

(52) U.S. Cl. 716/4; 716/5

(57) ABSTRACT

A method, an apparatus, and a computer program are provided for predicting power consumption for chip. The model for predicting power consumptions is modified so at to provide a high degree of accuracy with a minimal amount of computing time. Traditionally, when modeling a chip, a vast amount of time and computer resources were required to predict power consumption. Techniques required less time and less computer power, but the accuracy also decreased. However, by breaking down a chip into macros and developing energy rules for each macro, simple techniques can be employed to accurately predict power consumption under real world conditions with a minimal amount of time and computing power.

### FIELD OF THE INVENTION

The present invention relates generally to the computer modeling of Very Large-Scale Integration (VLSI) and, more particularly, to more accurately predicting power consumption with computer models.

### DESCRIPTION OF THE RELATED ART

In VLSI design, power consumption is a significant factor. Battery life, heat produced, packaging, and so forth can be adversely affected by power consumption. Hence, low power chips are desirable.

Estimation of power consumption begins with breaking a chip into smaller analytic components. The smaller analytic components are known as macros, which are essentially smaller block portions of a larger circuit. For example, a macro can be a latch, a raised cosine filter, or a variety of other components. Examining smaller components of a chip allow for convenience in modeling. There are also a variety of simulator software packages that can be used to construct circuits, for example Simulated Program for Integrated Circuits Emphasis (SPICE).

Typically, once the chip has been broken down into macros, an energy model for each macro can be developed based on the input pins. One conventional method is to use a logic simulator to obtain the average switching factors and the average power densities. Then based on the average switching factors and power densities, the power consumption for an entire chip can be extrapolated. Estimations based on these conventional methods may yield an overall maximum of power consumption; however, these conventional methods do not accurately model the fine grain clock gating that is required in a number of microprocessors today.

Full chip simulations, however, require a substantial amount of computer power and time. Making assumptions, though, to model the power consumption for an entire chip is inaccurate. Therefore, there is a need for a method and/or apparatus for modeling power consumption for a chip with varying circuit topologies that uses a reasonable amount of computer power and time that addresses at least some of the problems associated with conventional methods and apparatuses for modeling power consumption of a chip.

### SUMMARY OF THE INVENTION

The present invention provides a method, an apparatus, and a computer program for predicting power consumption of circuits on a chip. In order to predicting power consumption under real world conditions, the chip should first be separated into a plurality of macros. Once the chip has been broken down into smaller units, power consumption is then predicted for each macro. The power consumption predictions are based on a plurality of switching factors for each macro of the plurality of macros. After a number of data points have been acquired which yield power consumptions at varying switching factors, power consumption for all switching factors for each macros can be extrapolated based on the plurality of switching factors for each macro to yield energy model data for each macro.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 is a block diagram depicting a modeled macro;

FIG. 2 is a flow chart depicting a methodology for determining power consumption;

FIG. 3 is a block diagram depicting the modules of a power consumption modeler; and

FIG. 4 is an example of an operational model of the power consumption of a given macro.

### DETAILED DESCRIPTION

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, details concerning network communications, electro-magnetic signaling techniques, and the like, have been omitted inasmuch as such details are not considered necessary to obtain a complete understanding of the present invention, and are considered to be within the understanding of persons of ordinary skill in the relevant art.

It is further noted that, unless indicated otherwise, all functions described herein may be performed in either hardware or software, or some combination thereof. In a preferred embodiment, however, the functions are performed by a processor such as a computer or an electronic data processor in accordance with code such as computer program code, software, and/or integrated circuits that are coded to perform such functions, unless indicated otherwise.

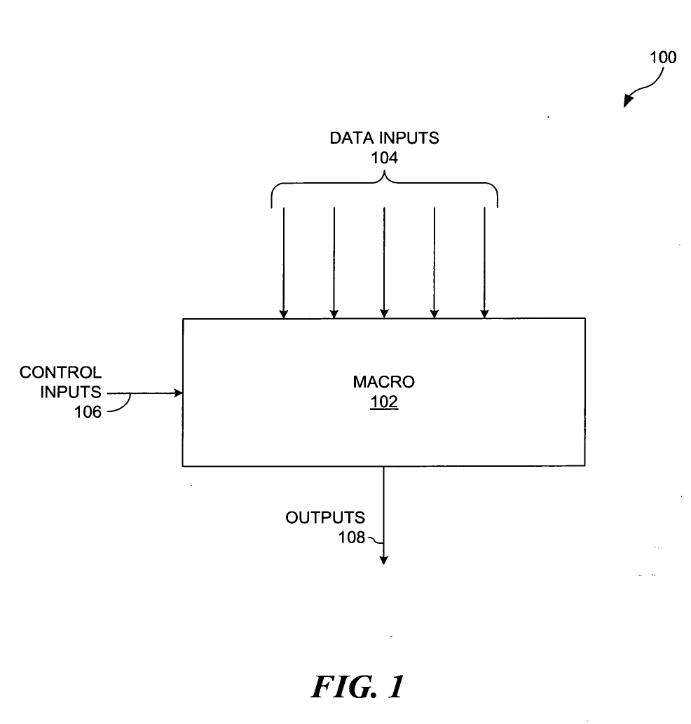

Referring to FIG. 1 of the drawings, the reference numeral 100 generally designates macro. The modeled macro 100 comprises a macro 102, a plurality of data inputs 104, a plurality of control inputs 106, and a plurality of outputs 108.

The modeled macro 100 is utilized to generate energy model data. The switching factors of the plurality of data inputs 104 and the control inputs 106 of the macro 102 are varied to output data through the plurality of outputs 108. The macro 102 can be a variety of macro types, such as a latch macro. A switching factor is a percentage of the inputs that toggle after a given cycle. For example, a fifty percent switching factor is at a time where one-half of the input pins are toggled. Measurements of the power consumption at various switching factors are taken. Typically, power consumption measurements are taken at fifty percent, at one hundred percent, and at zero percent. However, more data points can be gathered by taking measurements at a variety of other switching factors. Once the power consumption measurements have been taken, then power at a given switching factor can be extrapolated from the power consumption measurements. These extrapolations of power consumption for a given switching factors are the energy model data. Also, the extrapolations can encompass a variety of linear and non-linear extrapolation techniques, such a least square fitting and splines.

The modeled macro 100, however, does not have to be completed either to determine the energy model data for power consumption. In fact, macros, such as the macro 102, can be modeled at various stages of design and development to determine relative amounts of power consumption. By allowing a designer to be able to model power consumption of a given macro at every stage of development, the time required to design a specific macro or chip is substantially reduced. Also, modeling the macro can assist a designer in the development because of the known power consumptions as the design progresses.

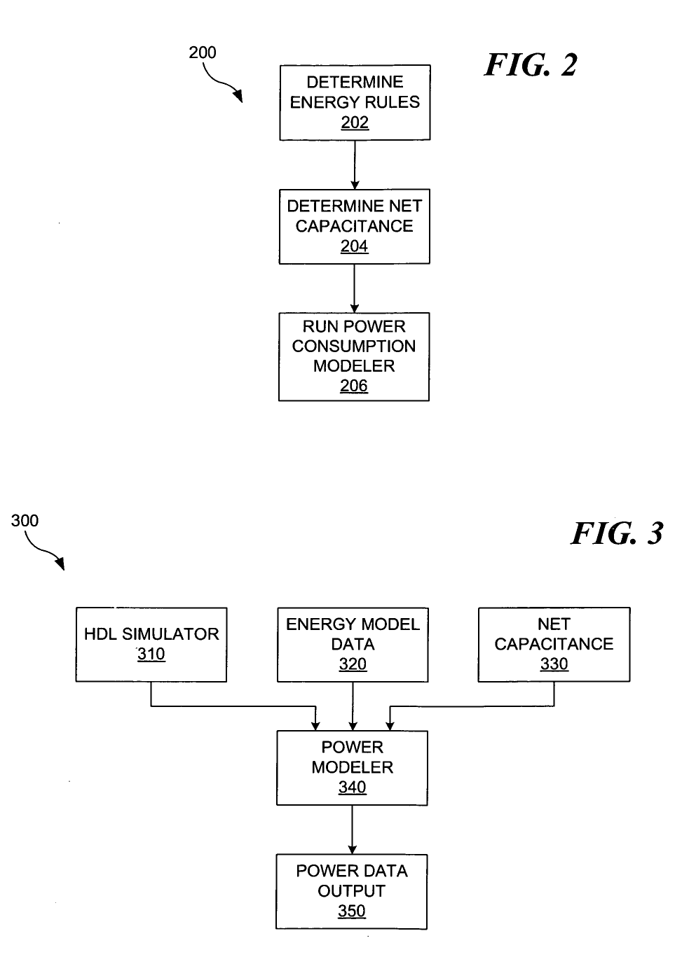

Referring to FIG. 2 of the drawings, the reference numeral 200 depicts a flow chart of a methodology for determining power consumption.

In step 202, the energy model data is determined. A determination of the energy model data is typically made from the modeled macro 100 of FIG. 1. A modeling tool is utilized to input data into the macro 102 of FIG. 1 at random. Typically, with a higher switching factor, there is an increase in power consumption. Sometimes, however, it may be necessary to calculate the power over time instead of relative power consumption for a given switching factor. Hence, the modeled macro 100 also has the capability to provide power over time on a cycle-by-cycle basis.

The net capacitance should then be calculated in step 204. Chip floor plans, with all of the respective macro placements, are utilized. Based on the layout and the capacitance of the individual macros, an overall net capacitance for the chip can be determined.

In step 206, the power consumption modeler is run. The power consumption modeler combines the data generated as a result of the net capacitance determination and the energy model data. The net power consumption can be determined for each cycle. Different workloads and logic implementations can be utilized when running the power consumption modeler to determine power consumption of a variety of situations without having to reformulate the net capacitance or the energy model data.

As a result of the methodology for determining power consumption, the design time decrease while maintaining a high degree of accuracy. Due to energy model data for macros being stored, design patterns can be varied to minimize power usage. Moreover, accurate power estimations for large custom microprocessors can be made with low processing time requirements.

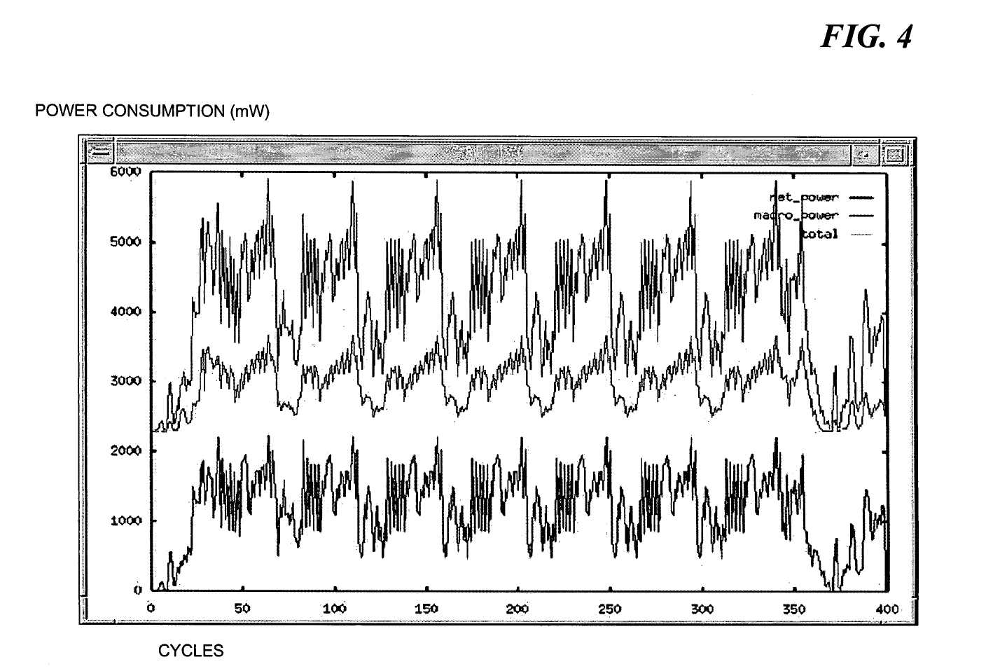

Referring to FIG. 3 of the drawings, the reference numeral 300 depicts a block diagram of the modules of a power consumption modeler. A Hardware Descriptive Language (HDL) simulation 310, the energy model data 320 (generated in FIG. 1), and the macro net capacitance 330 are input into the power modeler 340. The power modeler 340 can then generate an operational model of the power consumption as the macro operates. The power modeler 340 then outputs power data output 350. FIG. 4 is an example of an operational model of the power consumption of a given macro.

There are numerous benefits to utilizing the power consumption modeler. The amount of computing power and time required is minimized because each of the macros has an individual energy model. Moreover, the power consumption modeler has the ability to determine power consumption on a cycle-by-cycle basis and to predict power usage over time. Also, power consumption predictions can be made for macros in various stages of completeness.

It is understood that the present invention can take many forms and embodiments. Accordingly, several variations may be made in the foregoing without departing from the spirit or the scope of the invention. The capabilities outlined herein allow for the possibility of a variety of programming models. This disclosure should not be read as preferring any particular programming model, but is instead directed to the underlying mechanisms on which these programming models can be built.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of preferred embodiments. Accordingly, it is appropriate that the appended claims be construed broadly and in a manner consistent with the scope of the invention.

1. A method for predicting power consumption of circuits on a chip, comprising:
separating the chip into a plurality of macros;
predicting power consumption for a plurality of switching factors for each macro of the plurality of macros; and
extrapolating power consumption for all switching factors for each macros based on the plurality of switching factors for each macro to yield energy model data for each macro.

2. The method of claim 1, wherein the step of extrapolating is at least accurate enough to model fine grain clock gating.

3. The method for predicting power consumption of claim 1, wherein the step of extrapolating further comprising determining power consumption by a methodology selected from the group consisting of a linear technique, a least square technique, and a non-linear technique.

4. The method for predicting power consumption of claim 1, wherein the method further comprises:
determining a net capacitance for a chip;
inputting Hardware Descriptive Language (HDL) data into power modeler;
inputting the net capacitance into the power modeler;
inputting the energy model data for each macro into the power modeler; and
determining power consumption on a cycle-by-cycle basis based on the HDL data, the net capacitance, and the energy model data for each macro.

5. The method for predicting power consumption of claim 4, wherein the step of determining power consumption further comprising determining power over time.

6. The method for predicting power consumption of claim 1, wherein the method further comprises:
laying out the plurality of macros into a floor plan; and
determining a net capacitance for the floor plan.

7. The method for predicting power consumption of claim 6, wherein the method further comprises:
inputting HDL data into power modeler;
inputting the net capacitance into the power modeler;
inputting the energy model data for each macro into the power modeler; and
determining power consumption on a cycle-by-cycle basis based on the HDL data, the net capacitance, and the energy model data for each macro.

8. The method for predicting power consumption of claim 7, wherein the step of determining power consumption further comprising determining power over time.

9. An apparatus for predicting power consumption of circuits, comprising:
a chip comprising a plurality of macros;
a power consumption prediction module, wherein the power consumption prediction module is at least configured to predict power consumption for a plurality of switching factors for each macro of the plurality of macros; and
a power consumption template, wherein the power consumption template comprises energy model data for all switching factors for each macros based on the plurality of switching factors for each macro to generated by the power consumption prediction module.

10. The apparatus of claim 9, wherein the power consumption template is at least configure to be accurate enough to model fine grain clock gating.

11. The apparatus for predicting power consumption of claim 9, wherein the power consumption template further comprises an extrapolator for determining power consumption that at least employs a methodology selected from the group consisting of a linear technique, a least square technique, and a non-linear technique.

12. The apparatus for predicting power consumption of claim 9, wherein the apparatus further comprises:
a net capacitance measurement module to produce a net capacitance;
a HDL data generator to produce HDL data; and
a power predictor, wherein the power predictor is at least configured to determining power consumption on a cycle-by-cycle basis based on the HDL data, the net capacitance, and the energy model data for each macro.

13. The apparatus for predicting power consumption of claim 12, wherein the power predictor is at least configured to determine power over time.

14. The apparatus for predicting power consumption of claim 9, wherein the method further comprises:
a chip layout module, wherein the chip layout module is at least configured to laying out the plurality of macros into a floor plan; and
a net capacitance measurement module to produce a net capacitance for the floor plan.

15. The apparatus for predicting power consumption of claim 14, wherein the apparatus further comprises:
an HDL data generator to produce HDL data; and
a power predictor, wherein the power predictor is at least configured to determining power consumption on a cycle-by-cycle basis based on the HDL data, the net capacitance, and the energy model data for each macro.

16. The apparatus for predicting power consumption of claim 15, wherein the power predictor is at least configured to determine power over time.

17. A computer program product for predicting power consumption of circuits on a chip, the computer program product having a medium with a computer program embodied thereon, the computer program comprising:
computer code for separating the chip into a plurality of macros;
computer code for predicting power consumption for a plurality of switching factors for each macro of the plurality of macros; and
computer code for extrapolating power consumption for all switching factors for each macros based on the plurality of switching factors for each macro to yield energy model data for each macro.

18. The computer program product of claim 17, wherein the computer code for extrapolating is at least accurate enough to model fine grain clock gating.

19. The computer program product for predicting power consumption of claim 17, wherein the computer code for extrapolating further comprising computer code for determining power consumption by a methodology selected from the group consisting of a linear technique, a least square technique, and a non-linear technique.

20. The computer program product for predicting power consumption of claim 17, wherein the computer program product further comprises:
computer code for determining a net capacitance for a chip;
computer code for inputting HDL data into power modeler;
computer code for inputting the net capacitance into the power modeler;
computer code for inputting the energy model data for each macro into the power modeler; and
computer code for determining power consumption on a cycle-by-cycle basis based on the HDL data, the net capacitance, and the energy model data for each macro.

21. The computer program product for predicting power consumption of claim 20, wherein the computer code for determining power consumption further comprising computer code for determining power over time.

22. The computer program for predicting power consumption of claim 17, wherein the computer further comprises:
computer code for laying out the plurality of macros into a floor plan; and
computer code for determining a net capacitance for the floor plan.

23. The computer program product for predicting power consumption of claim 22, wherein the computer program product further comprises:
computer code for inputting HDL data into power modeler;
computer code for inputting the net capacitance into the power modeler;
computer code for inputting the energy model data for each macro into the power modeler; and
computer code for determining power consumption on a cycle-by-cycle basis based on the HDL data, the net capacitance, and the energy model data for each macro.

24. The computer program product for predicting power consumption of claim 23, wherein the computer code for determining power consumption further comprising computer code for determining power over time.
